(19) United States
(12) Patent Application Publication
(10) Pub. No.: US 2010/0238644 A1
(43) Pub. Date: Sep. 23, 2010

(54) Desk lamp

(76) Inventors: Tai-Hsiang Huang, Yongkang City (TW); Kuan-Hsiang Huang, Yongkang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/382,512

(22) Filed: Mar. 18, 2009

(51) Int. Cl. F21V 13/00

(52) U.S. Cl. 362/33

(57) ABSTRACT

This invention relates to a desk lamp in which the base of desk lamp is provided with a power lead having a transformer-type plug at one end for plug-in connection with a socket connecting to commercial electricity, a battery chamber within the base for receiving batteries, and a light regulating circuit within the base which has a light regulating knob provided on and protruded to the outside of the base. In this way, the desk lamp not only can be lighten up for illumination purpose under different type power supply such as commercial electricity or battery, but also the light intensity of desk lamp can be regulated through the light regulating circuit by the light regulating knob according to user's demand. In addition, the desk lamp can be used as an emergency light by the use of additionally added batteries. Therefore, it has better performance in total practical application.

### BACKGROUND OF THE INVENTION

1. Field of the Invention

This invention relates to a desk lamp, particularly to a desk lamp which can be lighten up for illumination purpose under different type power supply, and the light intensity of which can be regulated through a light regulating circuit by a light regulating knob according to user's demand. In addition, the desk lamp can be used as an emergency light in electric power cut state by the use of additionally added batteries. Therefore, it has better performance in its total practical application.

2. Brief Description of the Prior Art

In order to enhance the low light intensity caused by low illumination lamp, far-site installation of lamp or obstruction of light emitted from the lamp, the industries have developed various types of desk lamp for near-site installation by which general user can put it nearby and turn on it for better illumination purpose such that user can avoid fatigue or uncomfortableness of eye, vision decline etc. due to insufficiency in luminance of lighting during reading, writing or operating of personal computer.

The above desk lamp can reach expected effectiveness of illumination and near-site installation, however following defects has been found in practical application.

1. The above desk lamp only can obtain power supply from commercial electricity by the plug-in connection of a plug-attached power lead to a socket connecting to commercial electricity such that the desk lamp fails to lighten up under socket-void (for example: outdoor) condition.

2. The above desk lamp only provides ON-OFF switch for the ON-OFF of the desk lamp. Thus, this will cause great inconvenience, as the light intensity cannot be regulated according to user's demand.

3. In the case of electric power cut condition, pitch dark in the circumference caused by the die-out of lighting will bring about great inconvenience, as the desk lamp fails to provide required light for illumination anymore.

In view of the above facts, inventor of the present invention provides a new desk lamp according to the improvemet conducted on defects of the existing structure based on his abundant experience of R&D and manufacturing in relevant field so as to attain better performance in practical application.

### SUMMARY OF THE INVENTION

In order to achieve the above object, this invention provides a desk lamp in which the base of desk lamp is provided with a power lead having a transformer plug at one end for plug-in connection with a socket connecting to commercial electricity, a battery chamber within the base for receiving batteries, and a light regulating circuit within the base which has a light regulating knob provided on and protruded to the outside of the base. In this way, not only the desk lamp can be lighten up for illumination purpose under different type power supply such as commercial electricity or battery, but also the light intensity of desk lamp can be regulated through the light regulating circuit by the light regulating knob according to user's demand. In addition, the desk lamp can be used as an emergency light by the use of additionally added batteries. Therefore, it has better performance in its total practical application.

### BRIEF DESCRIPTION OF THE DRAWINGS

The present invention will be better understood by referring to the accompanying drawings, wherein:

FIG. 1 is a perspective appearance view showing the desk lamp of the present invention.

FIG. 2 is a partial perspective enlarged view showing the desk lamp of the present invention.

FIG. 3 is a partial perspective enlarged view showing the desk lamp of the present invention.

FIG. 4 is a view showing the structure of the drive circuit of the desk lamp of the present invention.

### DETAILED DESCRIPTION OF THE PREFERRED EMBODIMENTS

The objects, the technical contents and the expected effectiveness of the present invention will become more apparent from the detailed description of the preferred embodiment in conjunction with the accompanying drawings.

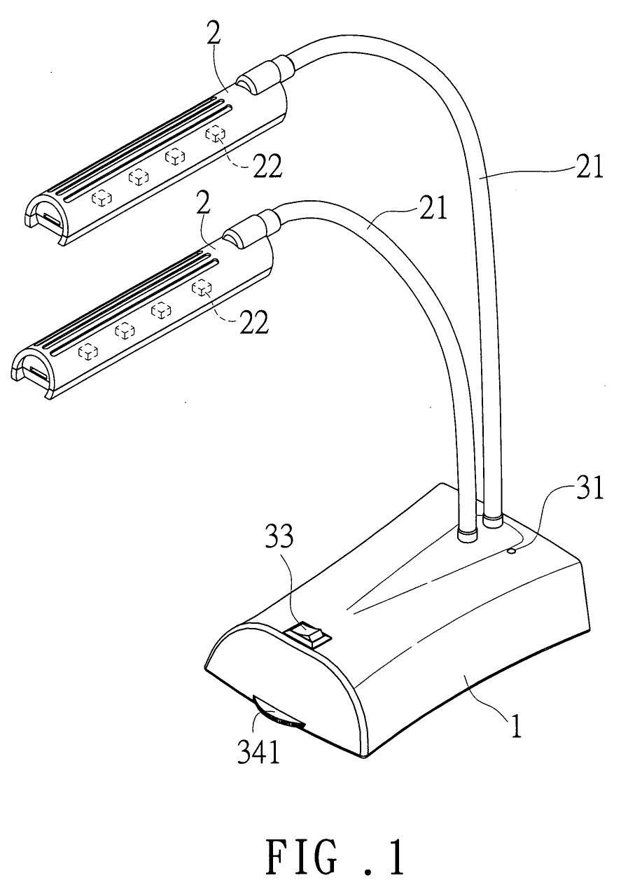

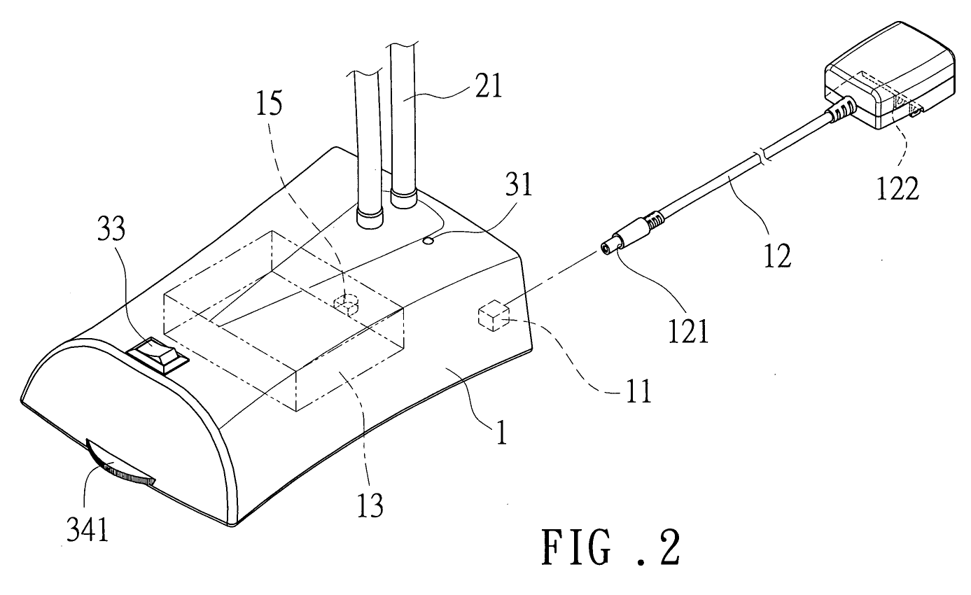

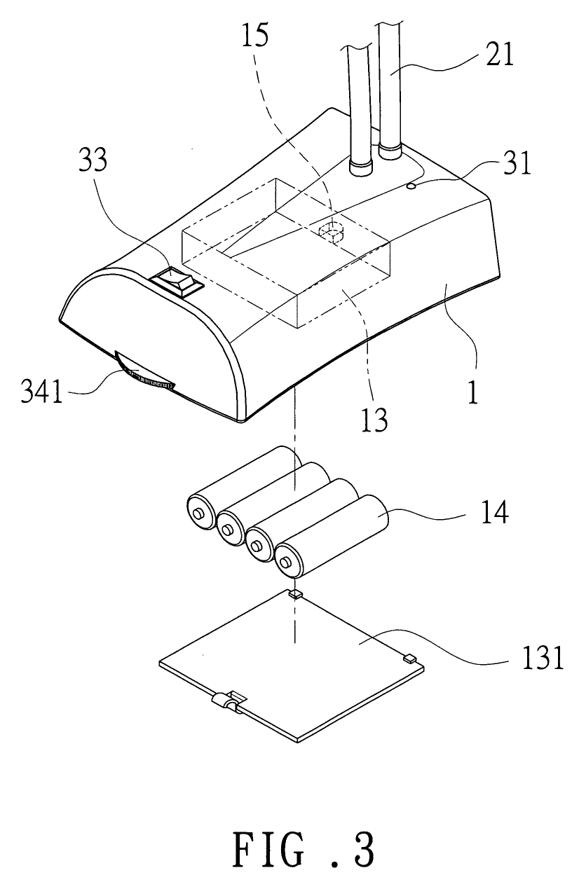

Firstly referring to FIG. 1 showing a perspective appearance view of the desk lamp of the present invention, the base (1) of the desk lamp of the present invention has a lamp seat (2) connected by a connecting rod (21). A plurality of LED (light emitting diode) is provided inside the lamp seat (2). A coupling port (11) is provided on the base (1) for plug-in connection of a mating coupler (121) provided at one end of a power lead (12). A transformer plug (122) is provided at the other end of the power lead (12), as shown in FIG. 2 showing a perspective enlarged view of the desk lamp of the present invention. A battery chamber (13) for accommodating batteries is also provided in the base (1) and is covered by a lid (131), as shown in FIG. 3 showing a partial perspective enlarged view of the desk lamp of the present invention. A hole (15) for hanging purpose is provided on the bottom of the base (1).

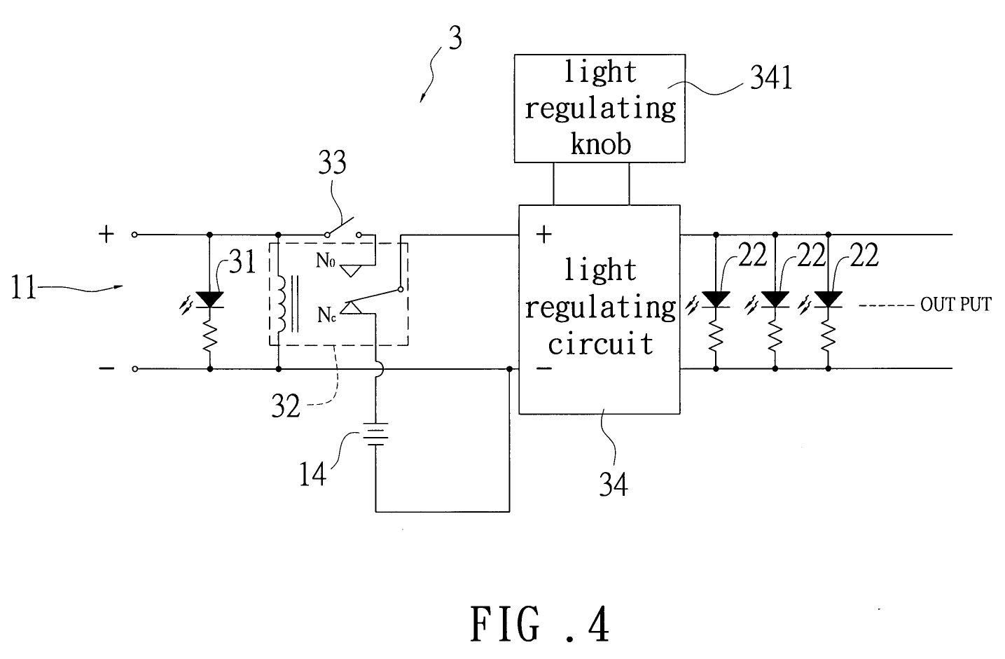

Referring to FIG. 4 showing the structure of a drive circuit of the desk lamp of the present invention, a drive circuit (3) is provided within the base (1). The drive circuit (3) has a power indicator lamp (31) provided on the input end of the transformer plug (122). The power indicator lamp (31) is protruded to the outside of the base (1). A relay (32) is connected to the input end of the transformer plug (122). The NO (normally-opened) contact of the relay (32) is connected to a switch (33) which is provided on and protruded to the outside of the base (1), while the NC (normally closed) contact is connected to the battery (14). Further, a light regulating circuit (34), which can be a varistor, is provided in the rear cascade connection of the relay (32). The light regulating circuit (34) is provided with a light regulating knob (341) which is also protruded to the outside of the base (1). The output end of the light regulating circuit (34) is connected to each LED (22) provided in the lamp seat (2).

Thus, the coupling port (11) of the base (1) is in mating connection with the mating coupler (121) at one end of the power lead (12), and the transformer plug (122) at the other end of the power lead (12) is in plug-in connection with a socket connecting to commercial electricity. Alternatively, batteries (14) are accommodated within the battery chamber (13) of the base (1). When the transformer plug (122) is in plug-in connection with a socket connecting to commercial electricity, the power indicator lamp (31) is turned on, and electric current passes through the coil of the relay (32) to cause the NO contact to close and NC contact to open. If user operate the switch (33) at this state, the power input through the transformer plug (122) can be supplied to each LED (22) within the lamp seat (2) through the light regulating circuit (34) so as to light up each LED (22) for illumination. The light intensity of each LED (22) can be adjusted by the light regulating knob (341) provided on and protruded to the outside of the base (1). When the coupling port (11) of the base (1) is not in mating connection with the power lead (12) or when in electric power cut state, the power indicator lamp (31) of the drive circuit (3) cannot be lighten up and the coil of the relay (32) is also de-energized due to electric power cut so that the NO contact is in normally opened state and the NC contact is in normally closed state. In this case, the LEDs (22) can get power supply from batteries (14) through the light regulating circuit (34) to be lighten up for illumination. The light intensity also can be adjusted by the light regulating knob (341) provided on and protruded to the outside of the base (1).

The abovementioned embodiment and drawings are not used to limit of the scope of the present invention. Equivalent variations and modifications made by the person skilled in the art without departing from the spirit and scope of the present invention are still considered to be further embodiments of the present invention.

Based on the foregoing, the caster of the present invention has the following advantages when comparing with the structure of conventional desk lamp.
1. The desk lamp of the present invention not only can get the supply of commercial electricity by the transformer plug of the power lead, but also can be energized by the batteries accommodated within the battery chamber of the base. Even in the case of electric power cut condition, the desk lamp can also be lighten up for illumination.
2. The desk lamp of the present invention is provided with a light regulating circuit in the drive circuit and with a light regulating knob protruded to the outside of the base such that the light intensity of each LED can be adjusted by the light regulating knob through the light regulating circuit according to user's demand. Therefore, convenience in application is enhanced.
3. If power electric cut is happened during the use of a desk lamp, power supply can be obtained from the batteries accommodated within the battery chamber by the switching of relay so that the desk lamp can be used as an emergency light.

Summing up above, the desk lamp of this invention can reach expected effectiveness, and the specific configurations disclosed herein have yet not seen in the prior art of the same category of product, even has not been opened to the public before application.

What is claimed is:

1. A desk lamp, wherein the desk lamp has a lamp seat connected by a connecting rod; a plurality of LED (light emitting diode) being provided inside the lamp seat; a coupling port being provided on the base for plug-in connection with a mating coupler provided at one end of a power lead; a transformer plug being provided at the other end of the power lead; a battery chamber for accommodating batteries being also provided in the base and being covered by a lid; a drive circuit being provided within the base, which has a relay provided at the input end of the transformer plug, the NO (normally-open) contact of the relay being connected to a switch which is provided on and protruded to the outside of the base, while the NC (normally closed) contact is connected to the battery; a light regulating circuit being provided in the rear cascade connection of the relay, said light regulating circuit being provided with a light regulating knob which is also protruded to the outside of the base;
the output end of the light regulating circuit being connected to each LED provided in the lamp seat.

2. A desk lamp as claimed in claim 1, wherein a hole for hanging purpose is provided on the bottom of the base.

3. A desk lamp as claimed in claim 1, wherein said drive circuit has a power indicator lamp provided on the input end of the transformer plug, said power indicator lamp being protruded to the outside of the base.

4. A desk lamp as claimed in claim 1, wherein said light regulating circuit is a varistor.
